(19) United States
(12) Patent Application Publication
(10) Pub. No.: US 2012/0187170 A1
(43) Pub. Date: Jul. 26, 2012

(54) STRUCTURE OF RING BUCKLE OF BICYCLE SADDLE BAG

(76) Inventor: KUO-PING HO, Taichung City (TW)

(21) Appl. No.: 13/350,840

(22) Filed: Jan. 16, 2012

(30) Foreign Application Priority Data
Jan. 25, 2011 (TW) 100201550
Nov. 18, 2011 (TW) 100221923

(51) Int. Cl. B62J 11/00

(52) U.S. Cl. 224/441

(57) ABSTRACT

An improved structure of ring buckle of bicycle saddle bag is provided for easily mounting a saddle bag to a bicycle saddle, including a saddle bag, a mounting strap or a mounting pad, and a fastening strap. The fastening strap is wrapped around to form a ring buckle for coupling with a seat tube of a bicycle saddle. The mounting strap or the mounting pad is mounted to a front side of the saddle bag so as to form an extend-through section on the front side of the saddle bag. The fastening strap is partially received in the extend-through section so that the ring buckle formed by the fastening strap is movable up and down on the front side of the saddle bag to adjust the mounting angle of the ring buckle for protecting stretching and deformation of the saddle bag caused by improper mounting angle.

### TECHNICAL FIELD OF THE INVENTION

The present invention generally relates to an improved structure of ring buckle of bicycle saddle bag, and more particularly to a ring buckle that allows of adjustment of mounting angle of a saddle bag mounted to a bicycle seat tube in order to protect the saddle bag from being stretched, deformed, and thus damaged due to an incorrect mounting angle.

### DESCRIPTION OF THE PRIOR ART

Besides exercise and body building, bicycles also comply with the trend of environmental conservation and energy saving and are thus always favorable to the public. The prevailing of bicycle exercise brings about developments of versatile bicycle accessories, some of which are used to carry and store articles on the bicycles, such as a bag or a basket. Taking the bicycle bag as an example, the bag can be mounted to different portions of a bicycle and is thus known of different names. For example, a bicycle bag that is mounted under a bicycle saddle is known as a “saddle bag”; a bag mounted to a rear rack is referred to as a “pannier” or a “rack bag”, and a bag mounted to a bicycle handlebar is named a “handlebar bag ” or a “handlebar basket”. Mounting a saddle bag to a bicycle has an advantage of providing a storage space when the bicycle is being ridden outdoors, whereby a cyclist can deposit small articles, such as mobile phones, changes, tools, and keys in the saddle bag to improve the convenience of bicycle riding.

A conventional saddle bag has a structure that comprises a fastening strap having a buckle ring fixed at an end. The fastening strap is wrapped around a bicycle seat tube and an end of the strap is extended through the buckle ring to fix and thus forming a ring buckle system that secures the saddle bag under the bicycle saddle and provides protection against shocks and vibrations occurring in bicycle riding. The strap of the conventionally structured ring buckle system is attached to the saddle bag through sewing so that the strap cannot be moved and adjusted as desired. When a specific saddle bag is mounted under a bicycle saddle of different style, the saddle bag often needs to be stretched and deformed and even damaged due to unmatched mounting angle.

Apparently, the known mounting structure of the bicycle saddle bags is generally imperfect and the present invention aims to improve the imperfection.

### SUMMARY OF THE INVENTION

The primary objective of the present invention is to provide an extend-through structure on a saddle bag in order to adjust the mounting angel of a ring buckle formed by a fastening strap in order to cope with any needs for mounting the saddle bag under a bicycle saddle and protect the saddle bag against undesired stretch and deformation and thus damage.

To achieve the above objective, the present invention provides a structure comprising a saddle bag, a mounting strap, and a fastening strap. The features are that the mounting strap has two ends that are mounted to a front side of a saddle bag to form an extend-through section. The fastening strap is received in the extend-through section. The fastening strap has an end forming a ring and an opposite end that extends through the ring and is subsequently jointed back to the fastening strap. The fastening strap is mounted to a seat tube of bicycle saddle to form a ring buckle, which is movable on the front side of the saddle bag to selectively set an optimum mounting angle between the ring buckle and the seat tube of the bicycle saddle.

Alternatively, the fastening strap is replaced by a rubber pull tab buckle device.

The present invention may alternatively provide a structure that comprises a saddle bag, a mounting pad, and a fastening strap. The features are that the mounting pad is mounted to a front side of the saddle bag. The mounting pad forms an extend-through section, in which the fastening strap is received and coupled. The fastening strap is mounted to a seat tube of bicycle saddle to form a ring buckle, which is movable on the front side of the saddle bag to selectively set an optimum mounting angle between the ring buckle and the seat tube of the bicycle saddle in order to cope with any needs for mounting the saddle bag under a bicycle saddle and protect the saddle bag against undesired stretch and deformation and thus damage and also shows a more appealing aesthetic visual perception.

The mounting pad comprises a sheet made of plastics. The sheet forms a raised section. The raised section has two side walls in which through slots are formed and communicate with each other to form the extend-through section.

As an alternative, the mounting pad comprises a sheet made of leather, the sheet forming cut slits in two opposite side portions thereof to define the extend-through section.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a first embodiment of the present invention.

FIG. 2 is a top plan view of the first embodiment of the present invention in an assembled form.

FIG. 3 is a side elevational view of the first embodiment of the present invention, illustrating selective movement of a ring buckle formed by a fastening strap on a saddle bag.

FIG. 4 is an exploded view showing a fastening strap of the first embodiment of the present invention.

FIG. 5 is a perspective view of FIG. 4 in an assembled form.

FIG. 6 shows a second embodiment of the present invention, in which a mounting strap is provided for coupling a rubber pull tab buckle device.

FIG. 7 illustrates the second embodiment of the present invention mounted under a saddle.

FIG. 8 is an exploded view showing a third embodiment of the present invention.

FIG. 8a is a cross-sectional view showing a mounting pad of the third embodiment of the present invention.

FIG. 9 is a perspective view of FIG. 8 in an assembled form.

FIG. 10 is an exploded view showing a fourth embodiment of the present invention.

FIG. 11 is a perspective view of FIG. 10 in an assembled form.

FIG. 12 is a perspective view illustrating the embodiment of FIG. 10 secured through sewing.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

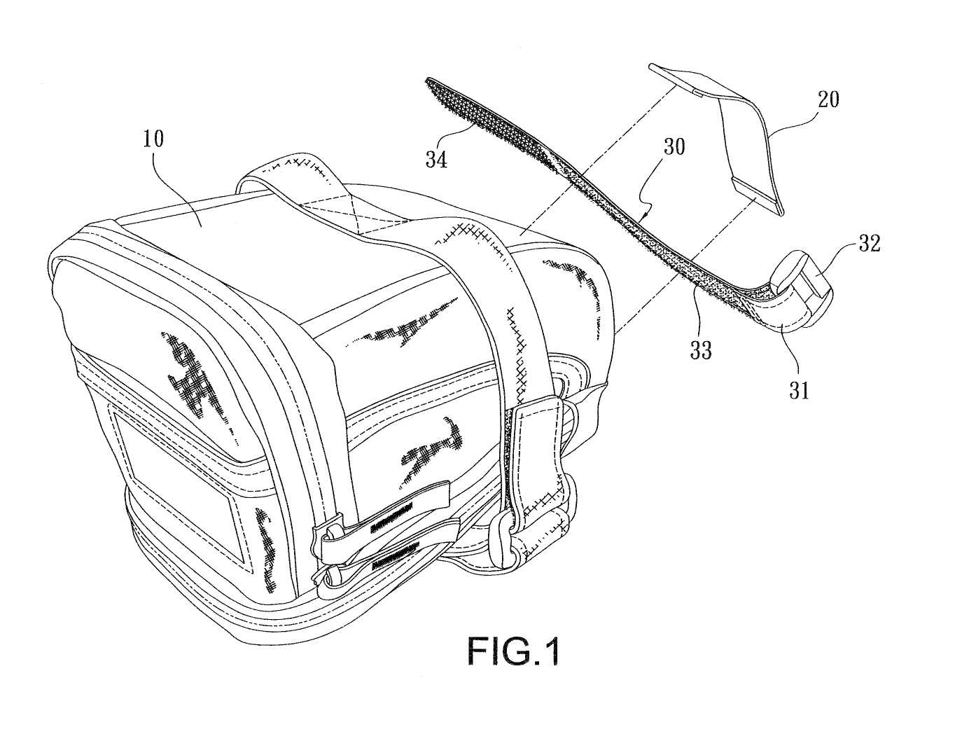

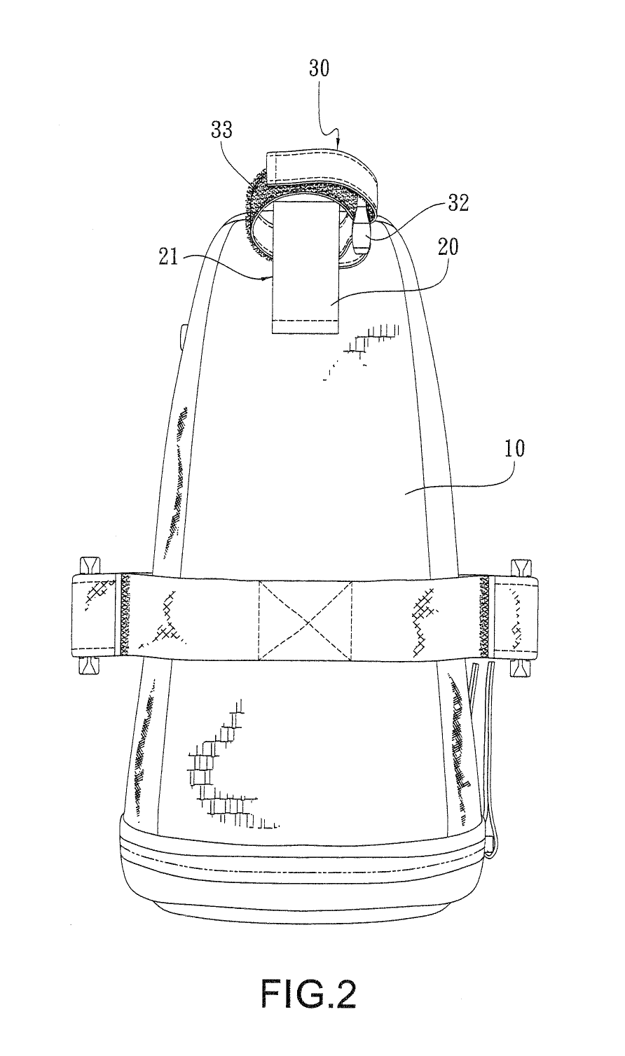

As shown in FIG. 1, the present invention provides a structure that comprises a saddle bag 10, a mounting strap 20, and a fastening strap 30. The mounting strap 20 is attached to a front side of the saddle bag 10 so that an extend-through section 21 (see FIG. 2) is formed between the saddle bag 10 and the mounting strap 20. The extend-through section 21 receives the fastening strap 30 to extend therethrough and thus allows the fastening strap 30 to do positional adjustment in a vertical direction on the front side of the saddle bag 10 thereby facilitating the mounting of the saddle bag 10 under a saddle of bicycle.

As shown in FIGS. 1 and 2, the mounting strap 20 is fixed in a substantially vertical manner by sewing upper and lower ends thereof to the saddle bag 10 or is fixed to the front side of the saddle bag 10 by means of other suitable means, such as hot pressing or adhesives, so as to form an extend-through section 21 between the saddle bag 10 and the mounting strap 20.

The fastening strap 30 is received in and extends through the extend-through section 21. The fastening strap 30 has an end forming a loop section 31 that couples a ring 32 having an inside diameter at least sufficient for the fastening strap 30 to extend therethrough. The fastening strap 30 has a surface forming a hook-and-loop fastening material based fastening surface 33. An opposite end of the fastening strap 30 is provided with an engaging section 34 that is attachable to and thus releasably fixed to the fastening surface 33.

As shown in FIG. 2, said opposite end of the fastening strap 30 is put through the ring 32 and backward folded and sewn to have the engaging section 34 and the fastening surface 33 tightly engaging each other thereby securing and preventing said opposite end of the fastening strap 30 from slipping of In this way, the fastening strap 30 forms a ring buckle that has an adjustable inside diameter and the size of which can be fixed after the adjustment is done. To use, the ring buckle formed by the fastening strap 30 can be fit over and thus wrapping around a seat tube under the bicycle saddle to securely fix the saddle bag 10.

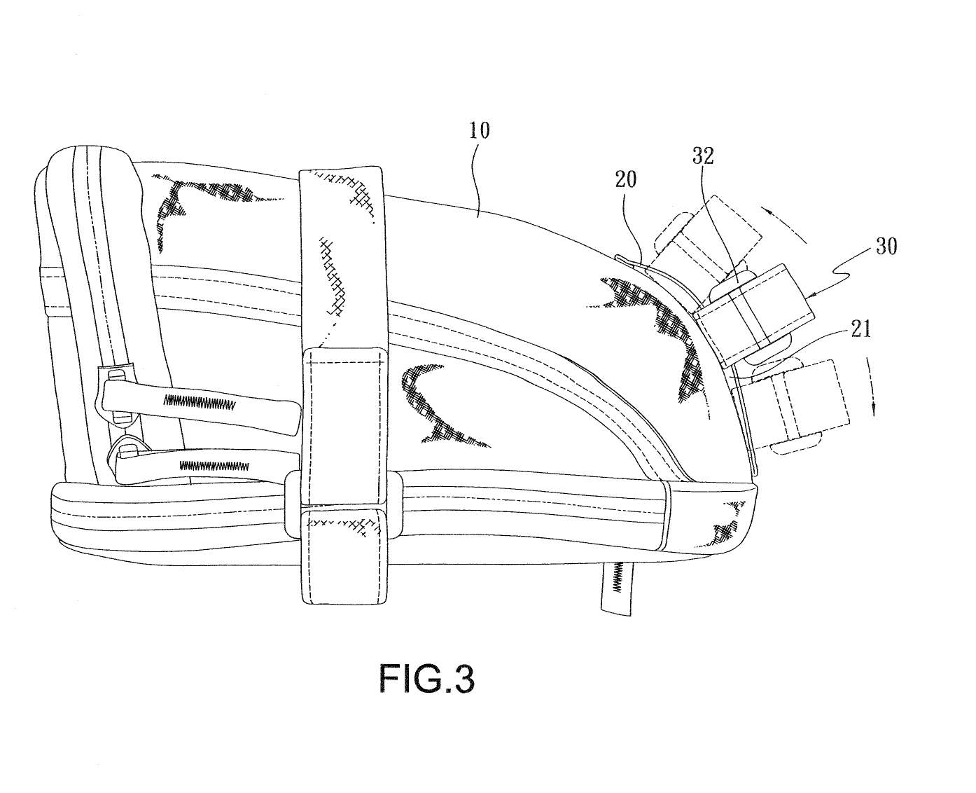

As shown in FIG. 3, the present invention provides an extend-through section 21, which besides receiving the fastening strap 30 to extend therethrough, allows the fastening strap 30 to selectively move up and down along the mounting strap 20 on the front side of the saddle bag 10 due to the extend-through section 21 having a length that exceeds width of the fastening strap 30 by a predetermined distance so that the mounting angle where fastening is to be done can be adjusted to eliminate the undesired situation of stretching and thus deforming the saddle bag 10 due to improper or unmatched mounting angle.

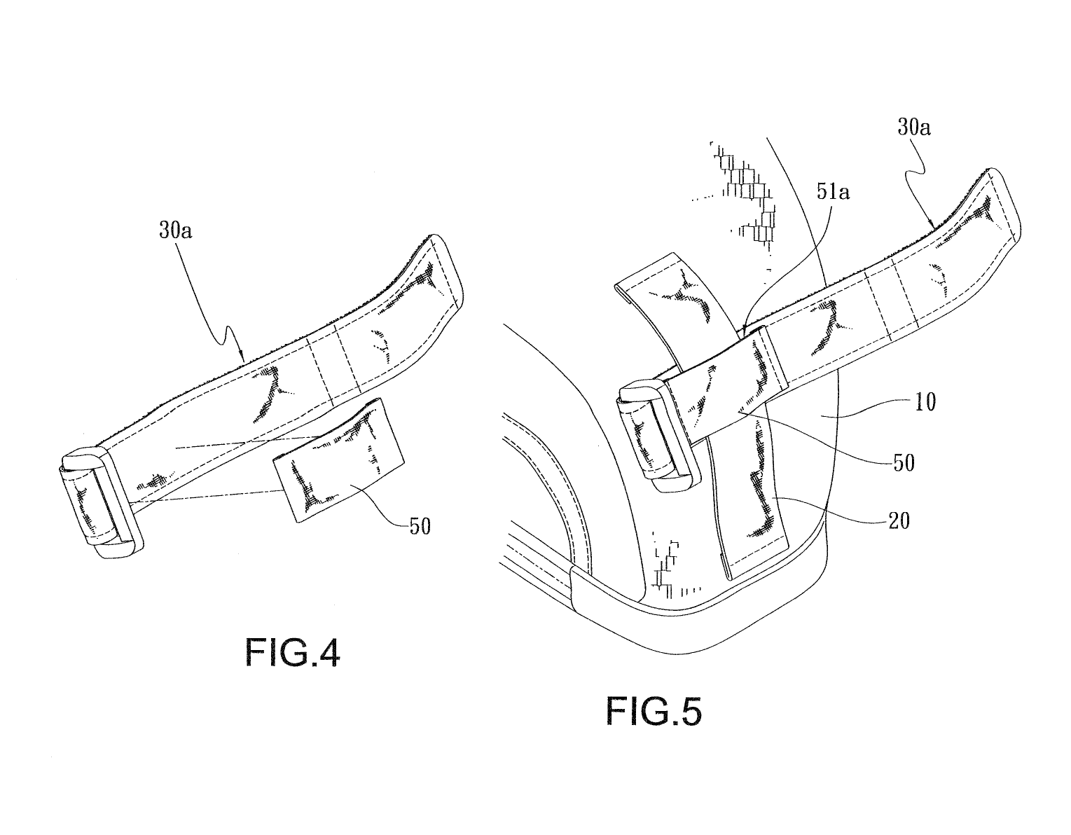

As shown in FIGS. 4 and 5, another embodiment of the present invention is illustrated, in which the fastening strap of the saddle bag 10 is modified in such a way that the fastening strap 30a comprises a constraint plate 50 mounted, through sewing, to a surface thereof that is opposite to the surface of the fastening strap that forms the fastening surface and the engaging section, namely the surface of the fastening strap 30a that opposes to and in engagement with the mounting strap 20. The constraint plate 50 is arranged substantially horizontally along the fastening strap and has two ends that are fixed to the surface of the fastening strap 30a by means of sewing or other fixing means, such as hot pressing and adhesive. This forms an extend-through section 51a between the fastening strap 30a and the constraint plate 50 to receive the mounting strap 20 to extend therethrough, so as to limit horizontal displacement of the fastening strap 30a and prevent the fastening strap 30a from undesired separation when the ring buckle has not yet been formed or not in use.

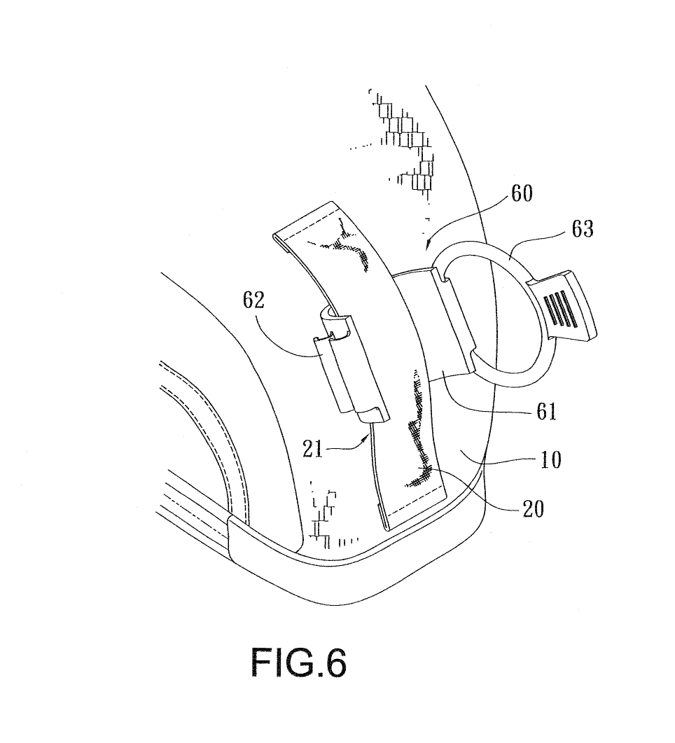

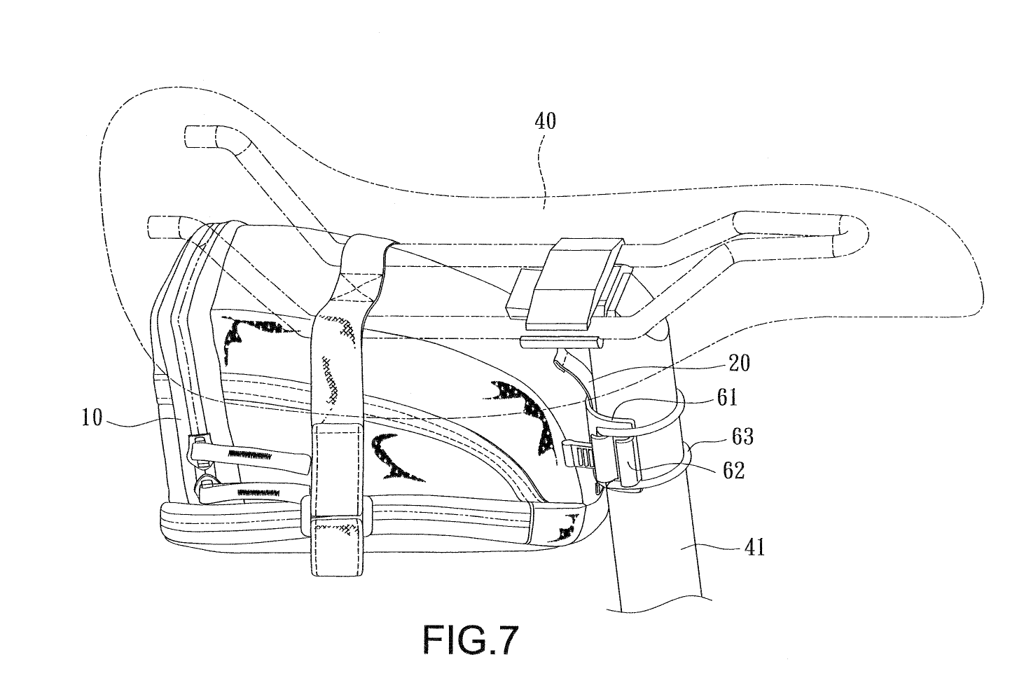

As shown in FIGS. 6 and 7, in another embodiment of the present invention, the fastening strap is replaced by a rubber pull tab based buckle device 60. The buckle device 60 comprises a base 61, which has an end forming a hook 62 and an opposite end forming a rubber pull ring 63. The base 61 extends through the extend-through section 21 below the mounting strap 20. Similarly, in fastening the rubber pull tab buckle device 60 to the seat tube 41 under the bicycle saddle 40 (as shown in FIG. 7), the buckle device is allowed of free adjustment in the vertical direction to reach an optimum position where the saddle bag 10 can be securely fixed.

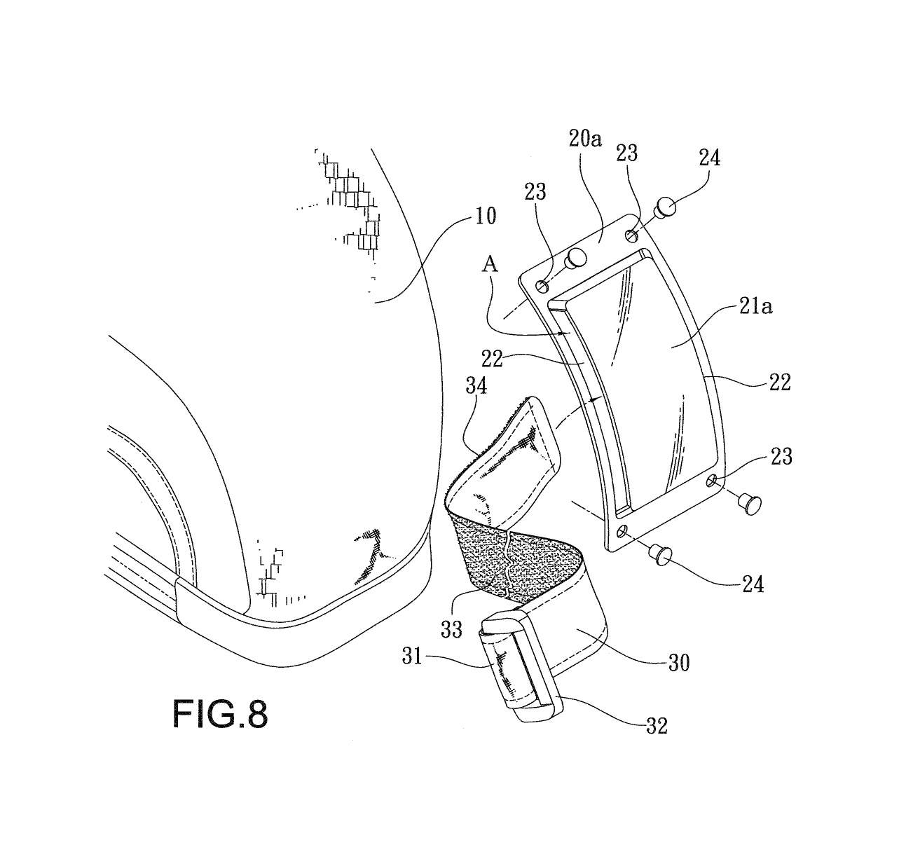

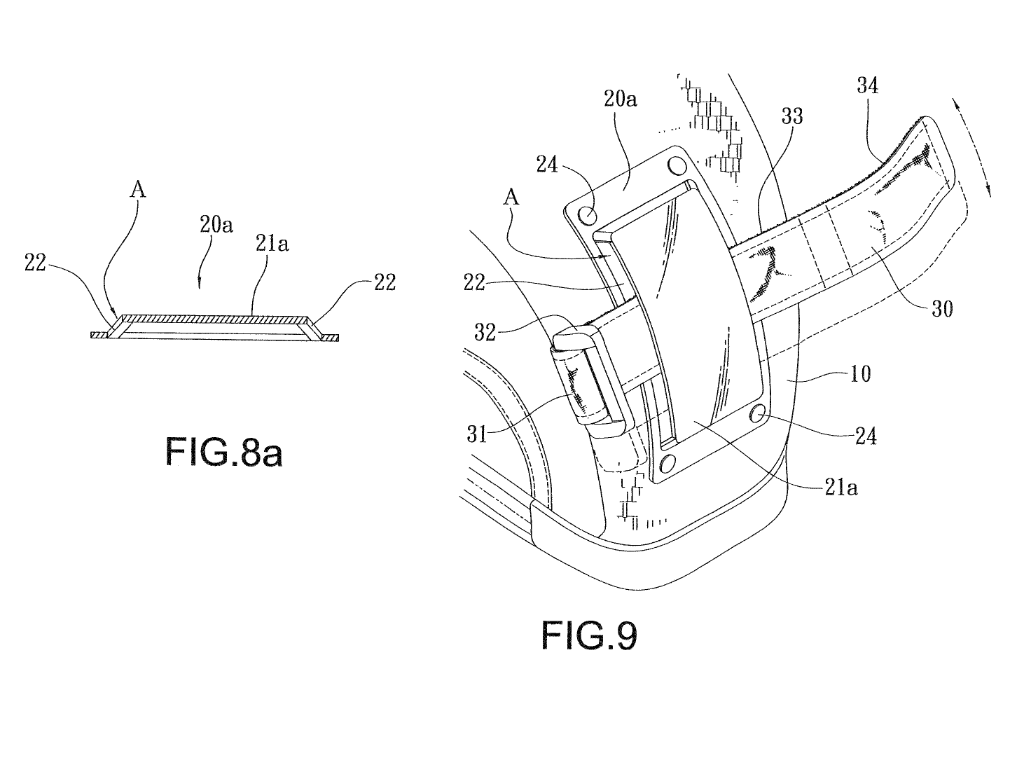

As shown in FIGS. 8, 8a, and 9, a further embodiment of the present invention is shown, which comprises a saddle bag 10, a mounting pad 20a, and a fastening strap 30. The mounting pad 20a is attached to a front side of the saddle bag 10 and the mounting pad 20a forms an extend-through section A that receives the fastening strap 30 to extend therethrough so as to set the fastening strap 30 on the front side of the saddle bag 10 in an extend-through fashion for free movement up and down for adjustment purposes thereby allowing the saddle bag 10 to be easily mounted under the bicycle saddle.

The mounting pad 20a comprises a thin plate or sheet integrally made of plastics, which is bendable to comply with the curve of the front side of the saddle bag 10. Alternatively, a plastic injection molding can be made to show a curved configuration corresponding to the curve of the front side of the saddle bag 10. The mounting pad 20a comprises a raised section 21a, which has two side walls in which through slots 22 are formed and communicate with each other to collectively define an extend-through section A (see FIG. 8a). Further, the plate or sheet of the mounting pad 20a forms through holes 23 in corners thereof to receive rivets 24 extending therethrough to fix to the saddle bag 10.

When the fastening strap 30 is extended through the extend-through section A, one end of the fastening strap 30 forms a loop section 31 that couples to a ring 32 having an inside diameter at least sufficient to receive the fastening strap 30 to extend therethrough. The fastening strap 30 has a surface forming a hook-and-loop fastening material based fastening surface 33. An opposite end of the fastening strap 30 is provided with an engaging section 34 that is attachable to and thus releasably fixed to the fastening surface 33.

To use, the fastening strap 30 is inserted through the extend-through section A of the mounting pad 20a and the inserted end is extended through the ring 32 and backward folded and sewn to have the engaging section 34 and the fastening surface 33 tightly engaging each other thereby securing and preventing the end of the fastening strap 30 from slipping off. In this way, the fastening strap 30 forms a ring buckle that has an adjustable inside diameter. The ring buckle formed by the fastening strap 30 can be fit over and thus wrapping around a seat tube under the bicycle saddle to securely fix the saddle bag 10.

As shown in FIG. 9, in the instant embodiment, the extend-through section A can receive the fastening strap 30 to extend therethrough and allows the fastening strap 30 to selectively move up and down on the front side of the saddle bag 10 due to the extend-through section A having a length that exceeds width of the fastening strap 30 so that the mounting angle where fastening is to be done can be adjusted to eliminate the undesired situation of stretching and thus deforming the saddle bag 10 due to improper or unmatched mounting angle

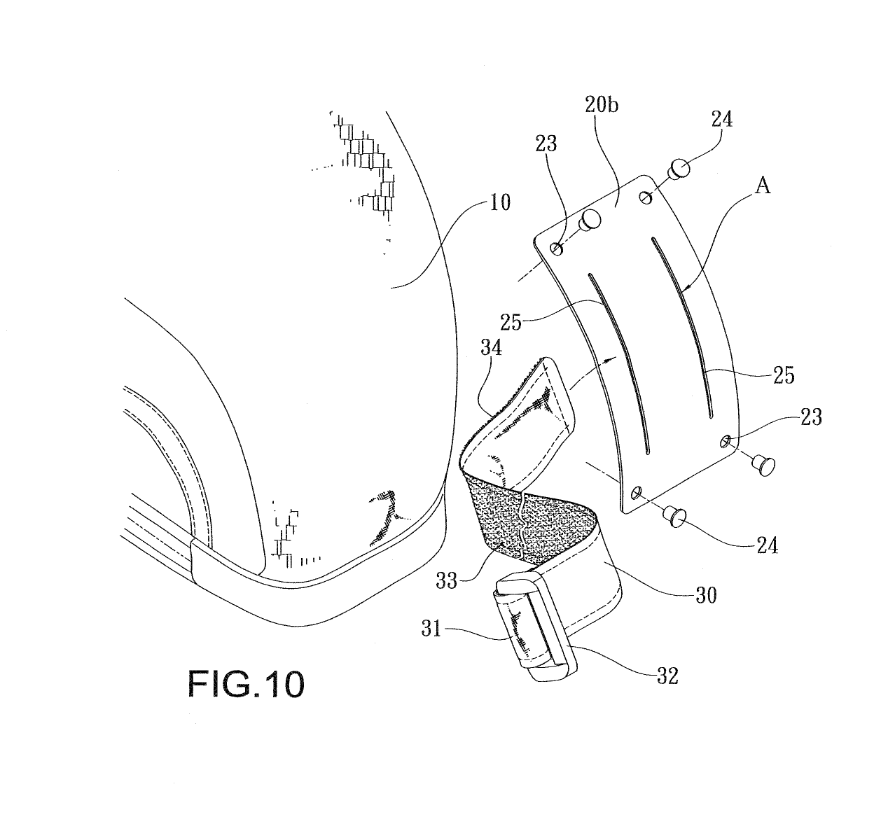

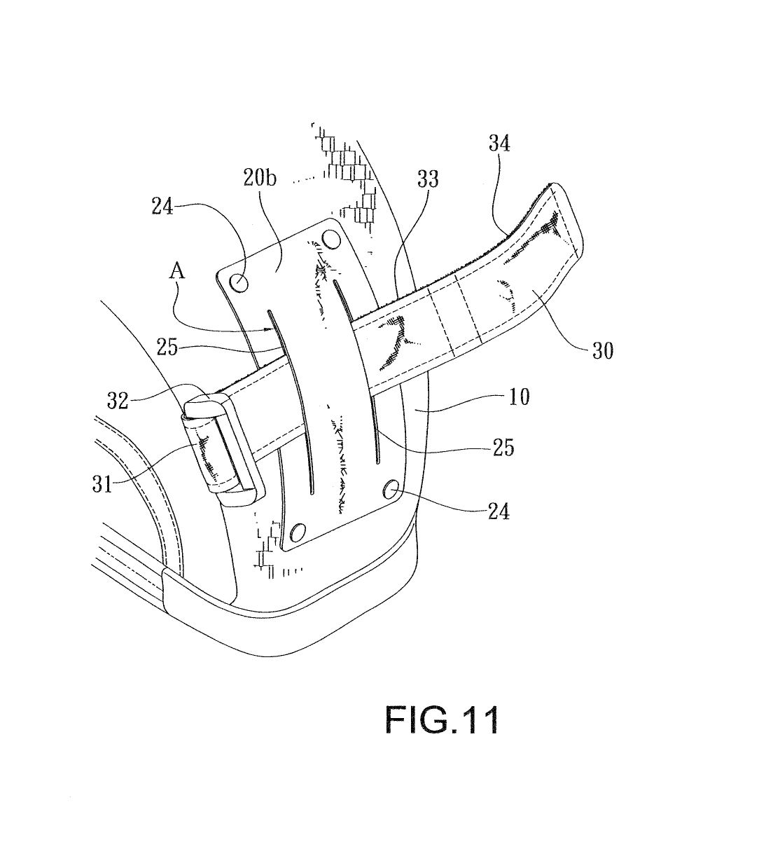

As shown in FIGS. 10-12, a further embodiment is shown, in which the material that makes the mounting pad is changed. In the instant embodiment, the mounting pad 20b comprises a thin plate or sheet made of leather. The sheet forms a cut slit 25 in each of two opposite side portions thereof to define an extend-through section A for receiving the fastening strap 30 to extend therethrough. The cut slits 25 have a length greater than width of the fastening strap 30 so that the fastening strap 30 is retained on the front side of the saddle bag 10 in an extend-through manner and is allowed to move up and down along the mounting pad 20b to realize adjustment of mounting angle at the fastening site.

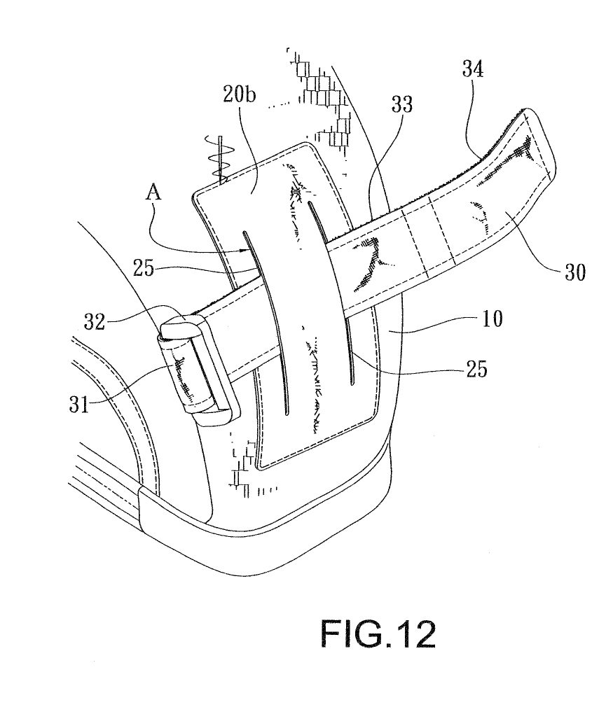

In the instant embodiment, the mounting pad 20b similarly forms through holes 23 in corners thereof to receive rivets 24 to extend therethrough for fixing to the saddle bag 10 (see FIG. 10). Alternatively, sewing can be made along edges of the mounting pad 20b to secure the sheet to the saddle bag 10 (see FIG. 12).

In summary, the present invention provides an extend-through structure on a saddle bag to realize adjustment of the mounting angle of a ring buckle system formed by the fastening strap in order to cope with any needs for mounting the saddle bag under a bicycle saddle and protect the saddle bag against undesired stretch and deformation and thus damage.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without

I claim:

1. A ring buckle of bicycle saddle bag, comprising a saddle bag, a mounting strap, and a fastening strap, characterized in that:
the mounting strap has two ends that are mounted to a front side of a saddle bag to form an extend-through section, the fastening strap being received in the extend-through section, the fastening strap having an end forming a ring, the fastening strap having an opposite end that extends through the ring and is subsequently jointed back to the fastening strap; and
the fastening strap is mounted to a seat tube of bicycle saddle to form a ring buckle, which is movable on the front side of the saddle bag to selectively set an optimum mounting angle between the ring buckle and the seat tube of the bicycle saddle.

2. The ring buckle of bicycle saddle bag according to claim 1, wherein the fastening strap has an end forming a loop section to couple with a ring.

3. The ring buckle of bicycle saddle bag according to claim 2, wherein the fastening strap has a surface forming a fastening surface, the fastening strap comprising an engaging section attachable to the fastening surface.

4. The ring buckle of bicycle saddle bag according to claim 1, wherein the fastening strap comprises a constraint plate and an extend-through section is formed between the fastening strap and the constraint plate.

5. A ring buckle of bicycle saddle bag, comprising a saddle bag, a mounting strap, a rubber pull tab buckle device, characterized in that:
the mounting strap has two ends that are mounted to a front side of the saddle bag to form an extend-through section, the rubber pull tab buckle device being in the extend-through section, the rubber pull tab buckle device having a base that has an end forming a hook and an opposite end forming a rubber pull ring; and
the rubber pull tab buckle device is mounted to a seat tube of bicycle saddle to form a ring buckle, which is movable on the front side of the saddle bag to selectively set an optimum mounting angle between the ring buckle and the seat tube of the bicycle saddle.

6. A ring buckle of bicycle saddle bag, comprising a saddle bag, a mounting pad, and a fastening strap, characterized in that:
the mounting pad is mounted to a front side of the saddle bag, the mounting pad forming an extend-through section, in which the fastening strap is received and coupled; and
the fastening strap is mounted to a seat tube of bicycle saddle to form a ring buckle, which is movable on the front side of the saddle bag to selectively set an optimum mounting angle between the ring buckle and the seat tube of the bicycle saddle.

7. The ring buckle of bicycle saddle bag according to claim 6, wherein the mounting pad comprises a sheet made of plastics, the sheet forming a raised section, the raised section having two side walls in which through slots are formed and communicate with each other to form the extend-through section.

8. The ring buckle of bicycle saddle bag according to claim 6, wherein the mounting pad comprises a sheet made of leather, the sheet forming cut slits in two opposite side portions thereof to define the extend-through section.

9. The ring buckle of bicycle saddle bag according to claim 7, wherein the mounting pad has corners in which through holes are formed to receive rivets to extend therethrough for fixing to the saddle bag.

10. The ring buckle of bicycle saddle bag according to claim 8, wherein the mounting pad has corners in which through holes are formed to receive rivets to extend therethrough for fixing to the saddle bag.

11. The ring buckle of bicycle saddle bag according to claim 8, wherein the mounting pad has edges that are fixed to the saddle bag by sewing.

12. The ring buckle of bicycle saddle bag according to claim 6, wherein the fastening strap has an end forming a loop section to couple with a ring.

13. The ring buckle of bicycle saddle bag according to claim 12, wherein the fastening strap has a surface forming a fastening surface, the fastening strap comprising an engaging section attachable to the fastening surface.
